(19) United States
(12) Patent Application Publication
(10) Pub. No.: US 2026/0072765 A1
(43) Pub. Date: Mar. 12, 2026

(54) CONTENTION PREDICTOR

(71) Applicant: Arm Limited, Cambridge (GB)

(72) Inventors: Eric Ola Harald LILJEDAHL, Stockholm (SE); Thomas Philip SPEIER, Wake Forest, NC (US); Matthew James HORSNELL, Cambridge, Cambridgeshire (GB); Joshua RANDALL, Austin, TX (US)

(21) Appl. No.: 18/883,287

(22) Filed: Sep. 12, 2024

(51) Int. Cl. G06F 9/52; G06F 9/48; G06F 9/50

(52) U.S. Cl. CPC G06F 9/52; G06F 9/4843; G06F 9/5061

(57) ABSTRACT

An apparatus comprises a contention predictor configured to predict, in response to a read/write trigger capable of causing a change of coherency state associated with cached data for a target address, a level of contention for access to the data corresponding to the target address; and control circuitry configured to select, based on the level of contention predicted by the contention predictor, a processing behaviour for processing the read/write trigger.

### BACKGROUND

### Technical Field

The present technique relates to the field of data processing.

### Technical Background

Some processing workloads may involve access to shared data by multiple threads running on respective processors (e.g. CPUs). In case of memory contention (multiple threads or processors accessing the same shared data, e.g. cache line, where at least one of the accesses involves a write to the shared data), the software may need to manage updates to the data so that respective updates to the shared data by different threads are synchronised. Such synchronisation techniques may have an impact on processing performance particularly in cases of high contention between many threads seeking to access the same data.

### SUMMARY

At least some examples of the present technique provide an apparatus comprising:
a contention predictor configured to predict, in response to a read/write trigger capable of causing a change of coherency state associated with cached data for a target address, a level of contention for access to the data corresponding to the target address; and
control circuitry configured to select, based on the level of contention predicted by the contention predictor, a processing behaviour for processing the read/write trigger.

At least some examples of the present technique provide a system comprising:
the apparatus described above, implemented in at least one packaged chip;
at least one system component; and
a board,
wherein the at least one packaged chip and the at least one system component are assembled on the board.

At least some examples of the present technique provide a chip-containing product comprising the system described above, wherein the system is assembled on a further board with at least one other product component.

At least some examples of the present technique provide a non-transitory computer-readable medium storing computer-readable code for fabrication of an apparatus as described above.

At least some examples of the present technique provide a method comprising:
predicting, in response to a read/write trigger capable of causing a change of coherency state associated with cached data for a target address, a level of contention for access to the data corresponding to the target address; and
selecting, based on the level of contention predicted by the contention predictor, a processing behaviour for processing the read/write trigger.

Further aspects, features and advantages of the present technique will be apparent from the following description of examples, which is to be read in conjunction with the accompanying drawings.

### BRIEF DESCRIPTION OF THE DRAWINGS

FIG. 1 illustrates an example of a processing apparatus;

FIG. 2 illustrates an example of a contention predictor;

FIG. 3 illustrates a method;

FIG. 4 illustrates an example of a processor-local contention predictor;

FIGS. 5A and 5B illustrates an example of a first mode being preferable in case of low contention and a second mode being preferable in case of high contention;

FIG. 6 illustrates an example of a home-node-local contention predictor;

FIG. 7 illustrates an example of an apparatus having both a processor-local contention predictor and a home-node-local contention predictor;

FIG. 8 illustrates an example of a prediction data structure for a contention predictor; and

FIG. 9 illustrates a system and a chip-containing product.

### DESCRIPTION OF EXAMPLES

The inventors have recognised that a processor executing a thread of processing involving read/write access to data in memory may support some processing behaviours which, while beneficial to processing performance in the case of no contention or low contention, can be highly disruptive to aggregated performance across multiple threads if there is high contention for access to shared data by multiple threads. It can be difficult for software to define in advance (at compile time) which strategy for read/write processing is best for a given workload, as the preferred strategy may depend on the number of threads being processed in parallel at runtime (which may vary based on operating system scheduling decisions, for example) or on the particular data sets being processed by the threads.

In the examples discussed below, an apparatus comprises a contention predictor configured to predict, in response to a read/write trigger capable of causing a change of coherency state associated with data corresponding to a target address, a level of contention for access to the data corresponding to the target address; and control circuitry configured to select, based on the level of contention predicted by the contention predictor, a processing behaviour for processing the read/write trigger.

Hence, by providing a contention predictor to predict the current level of contention associated with access to a particular target address likely to be subject to a read/write operation, the control circuitry can adapt the processing behaviour to the predicted level of contention for access to the target address. This can help improve average-case processing performance across memory accesses to addresses experiencing different levels of contention.

The read/write trigger could be any event associated with the target address which has the potential to cause a change of cache coherency state for data corresponding to the target address at a private cache of a given processor. The read/write trigger may be an event associated with either a read only, or a write only, or both a read and write (hence “read/write” is shorthand for “read and/or write”).

In some examples, the read/write trigger may comprise a read trigger, which has the potential to cause data to be read from the memory system and allocated into a cache. For example, the read trigger could be an instruction of a type which controls processing circuitry to issue a read coherence transaction specifying the target address, a read coherence transaction received at a home node, or a prefetch trigger when a prefetcher predicts that the target address should be prefetched into the cache (based on a prediction that the target address may be read in a future read operation).

In some examples, the read/write trigger may comprise a write trigger, which has the potential to trigger an update of data associated with the target address and cause a change of coherency state in at least one cache. For example, the write trigger could be an instruction of a type which controls processing circuitry to issue a read unique or write coherence transaction specifying the target address, a read unique or write coherency transaction received at a home node, or a prefetch trigger when a prefetcher predicts that data for the target address is likely to be written soon and so should be prefetched into the cache in a coherency state (such as an exclusive coherency state) suitable for such a write operation.

Hence, for both read and write operations, the processing behaviour selected for processing the read/write trigger can have an effect on the delays associated with contention for access to shared data, and so the coherency predictor could be used to predict level of contention for controlling processing behaviour of read triggers and/or write triggers. Some implementations may apply the contention predictor approach only for read triggers but not write triggers. Other implementations may apply the contention predictor approach only for write triggers but not read triggers. Other implementations may use contention prediction both for read triggers and write triggers.

In some examples, the control circuitry is configured to select, based on the level of contention predicted by the contention predictor, one of: a first processing behaviour which prioritizes improving single-threaded processing performance over multi-threaded processing performance; and a second processing behaviour which prioritizes improving multi-threaded processing performance over single-threaded processing performance. This recognises that some processing behaviours may be more beneficial to single-threaded processing performance (the performance achieved for a single thread in absence of any contending accesses from any other thread) but potentially harmful to the aggregate performance of multiple threads contending for access to shared data, while other processing behaviours may be beneficial to aggregate performance of the multiple threads in the case of high contention but may penalize performance of a single thread when there is low contention. Hence, the control circuitry can select the first processing behaviour when the predicted level of contention indicates a lower level of contention, and select the second processing behaviour when the predicted level of contention indicates a higher level of contention.

In some examples, the control circuitry is configured to select, based on the level of contention predicted by the contention predictor, a timing for issuing or processing a cache coherence transaction associated with the read/write trigger. The inventors recognised that by varying how early or late a cache coherency transaction is issued or processed relative to the timing when the read/write trigger is detected, this can adjust the balance between single-threaded processing performance and multi-threaded processing performance. Therefore, it can be useful to control the timing of issuing or processing the cache coherency transaction based on the prediction of the level of contention generated by the contention predictor.

In particular, the control circuitry may introduce a greater delay in issuing or processing the cache coherency transaction when the contention predictor predicts a higher level of contention than when the contention predictor predicts a lower level of contention. By delaying the cache coherency transaction associated with the read/write trigger when there is high contention, this can tend to reduce the effective duration of a critical section (a sequence of memory accesses to be observed as atomic) compared to cases where the cache coherency transaction associated with the read/write trigger is issued at an earlier timing. By reducing the duration of the critical section, this will tend to reduce the probability of overlap between critical sections executed by respective threads contending for access to the same shared memory data, which will tend to improve aggregated update rate to shared data by multiple threads and make it more feasible to scale to a greater number of threads while meeting acceptable performance requirements.

In some examples, the control circuitry is configured to select, based on the level of contention predicted by the contention predictor, a level of speculation aggression associated with speculatively processing the read/write trigger. When speculation is more aggressive, then in comparison to cases of lower speculation aggression, there may be a greater period between a time when a cache coherence transaction is issued to request data is cached in a particular coherency state and a time when an operation that requests a read/write to the target address is actually committed (determined with certainty to be required). In some processor designs which support one or more speculation techniques (such as prediction, prefetching, value prediction, address prediction, etc.), performance for a single thread can be improved by speculatively issuing the cache coherence transaction for the target address as early as possible (e.g. to fetch the data into a private cache for a read operation, or request access to data in an exclusive state ahead of a write), since this will tend to reduce the impact of cache miss and memory system access latency on overall thread performance for a single thread. However, the inventors recognised that in cases of high contention between multiple threads, aggressively speculating on reads/writes can harm overall aggregate performance for the multiple threads, as the effective duration of a critical section becomes longer. With a longer critical section, the number of threads contending for access at a given time is likely to be higher, and so more threads will be delayed waiting for successful completion of their critical section, reducing the aggregated update rate. Also, when there are more threads with overlapping critical sections, the memory system bandwidth consumed in “wasted” coherence transactions which relate to failed critical sections increases, wasting some update opportunities for the shared memory location and also reducing the available bandwidth for other more useful coherence transactions associated with operations that are making forward progress. Therefore, in cases of high contention it can be beneficial to reduce the level of speculation aggression (either by delaying the timing at which a read/write transaction is issued or processed speculatively, or by issuing the transaction non-speculatively, e.g. by waiting for an associated read/write instruction to be at the head of a commit queue before issuing the associated transaction). However, in cases of low contention a higher level of speculation aggression can be better for performance. By using the contention predictor, the speculation aggression can be adjusted depending on a prediction of current contention level to improve average case performance. In some examples, the control circuitry is configured to select a lower level of speculation aggression when the contention predictor predicts a higher level of contention than when the contention predictor predicts a lower level of contention.

In some examples, the control circuitry is configured to select, based on the level of contention predicted by the contention predictor, a coherency state in which the data associated with the target address is requested to be cached in a cache in response to the read/write trigger. In some examples (e.g. for read triggers), in response to the contention predictor indicating a lower level of contention, the control circuitry may cause the data associated with the target address to be cached in a shared coherency state, and in response to the contention predictor indicating a higher level of contention, the control circuitry may cause the data to be cached in an exclusive coherency state. In some examples (e.g. for write triggers), in response to the contention predictor indicating a lower level of contention, the control circuitry may cause the data associated with the target address to be cached in an exclusive coherency state, and in response to the contention predictor indicating a higher level of contention, the control circuitry may cause the data to be cached in an invalid coherency state (i.e. with a non-allocating write operation writing the data but not causing the data to be allocated into the cache). The exclusive coherency state (also known as a unique coherency state) may be a state in which data for a given address held in a private cache of a given processor may be modified by the given processor without issuing any further coherence transaction to a home node to check for whether other private caches also hold data for that address. The shared coherency state (also known as non-exclusive or non-unique coherency state) may be a state in which a modification of data for the target address held in a private cache of a given processor would require first issuing a coherency transaction to a home node in case other private caches also hold a copy of the data for the target address.

For read triggers, an approach of initially requesting the data to be allocated into the cache in shared state and later upgrading to exclusive state just before a write is needed may be more beneficial to single threaded performance but less beneficial to multi-threaded performance, so in cases of higher contention it may be more beneficial to initially request the data associated with the target address to be allocated into the cache in an exclusive coherency state (this may reduce the overall coherency transaction bandwidth consumed across all threads by coherence transactions seeking to negotiate access to the data for the target address). On the other hand, if the contention prediction associated with the target address indicates a lower level of contention, the coherence transaction issued to request reading of the data into the cache may specify that the data should be allocated in the shared coherency state (which will tend to cause the data to arrive earlier as there may be less need to wait on snoop responses to confirm invalidation of copies of data cached elsewhere than if caching in the exclusive coherency state is requested).

On the other hand, for write triggers, it may be that at low contention the most performant approach can be to initially request the data early in a unique state in response to the write trigger, but at high contention instead process the write trigger as a non-allocating write which causes the write performed with the data ending up in an invalid state with respect to a particular processor's private cache, to avoid moving the cache line into the private cache in an exclusive state, thereby enabling other threads to access the line subsequently with lower latency.

Non-allocating reads (reads which return data from memory to a target register without allocating the read data into a private cache of that processor) could also be used for read triggers in cases of predicted high contention, to reduce the effective number of requesters holding the data in their caches at a given time and so reduce the snooping overhead and response latency. This may also leave the data in exclusive state in another processor's private cache, enabling subsequent writes by that processor to complete with lower latency.

Hence, the control circuitry may, on some examples, select, based on the level of contention predicted by the contention predictor, whether to process the read/write trigger using a non-allocating read/write operation which reads/writes data for the target address without allocating the data request into a cache (the non-allocating read/write operation being more likely to be selected when the contention prediction predicts a higher level of contention for the target address than when the contention prediction predicts a lower level of contention for the target address).

The contention predictor may predict the level of contention based on looking up a prediction data structure based on at least the target address. The contention predictor may update the prediction data structure based on detection of contention hints indicative of an actual level of contention for access to data corresponding to respective addresses. Hence, the contention predictor may provide dynamic predictions of level of contention based on contention hints detected at runtime. This can be beneficial to performance because even when the same set of software is running on a given processing system, the actual level of contention may depend on the data set being processed by the software (e.g. in some cases the address access patterns may be data-dependent), and so the same set of software may sometimes experience high contention and other times experience low contention. In a given run, the dynamic updating of the prediction data structure based on contention hints detected at an earlier time in the run can be used to make predictions of the level of contention seen for a particular address later in the run, which can benefit overall processing performance by adapting the processing behaviour to the level of contention predicted to arise in later parts of the workload.

Various examples of contention hints are mentioned below, but in general the contention predictor may train the prediction data structure based on detecting events which indicate increased or decreased likelihood that there is contention between multiple threads for access to a particular address.

The contention predictor could be implemented at different locations in a processing system.

In some examples, the apparatus comprises a processor-local contention predictor associated with a given processor having the cache affected by the change of coherency state triggered based on the read/write trigger. In this case, the read/write trigger could, for example, be detection of an instruction for triggering a memory read/write operation for the target address, or the generation of a prefetch prediction that could cause a prefetch request to be issued for the target address. For a processor-local contention predictor, the control circuitry may control, based on the level of contention predicted by the processor-local contention predictor, issuing of cache coherence transactions from the given processor to a memory system.

With a processor-local contention predictor, there can be a challenge in that the processor-local contention predictor may not necessarily be aware of actions performed by processors other than the given processor associated with the contention predictor, so (unless there is feedback from a home node as discussed below for some examples), the processor-local contention predictor may need to infer contention hints from various events or metrics detected locally within the given processor. Nevertheless, a variety of contention hints can be available within the given processor.

One type of contention hint can be based on success/failure of a conditional write operation. It can be common, in workloads involving risk of multiple threads contending for access to shared memory data, to include a critical section of code which involves at least one conditional write operation which conditionally writes to memory dependent on a given condition being satisfied. For example, the critical section may include an atomic read/modify/write sequence terminating with the conditional write operation. For example, the conditional write operation could be triggered by an atomic compare-and-swap instruction specifying a given address, a compare value and a swap value. The atomic compare-and-swap instruction causes the current memory data value read for the given address to be compared with the compare value, and if the current memory data and compare value match (or otherwise satisfy a comparison condition), the condition is satisfied and the data at the given address is updated to be equal to the swap value. Another type of instruction that can be used to perform the conditional write is a store-exclusive instruction (explained further below). Regardless of the type of instruction used to trigger the conditional write operation, a conditional write operation can typically be used to detect whether there is risk of any intervening access by another thread to shared data in the period between an earlier read of the shared data and the conditional write operation, which might risk errors in updating the shared data due to lack of synchronisation between contending threads. Information about occurrence of success (condition satisfied) or failure (condition not satisfied) of a conditional write operation can therefore be an indication of the level of contention of access to shared data, because in cases of high failure rate then it is likely the data at the target address is more heavily contended. Therefore, in some examples, the processor-local contention predictor may update the level of contention predicted for a given address based on a conditional write outcome indication indicative of whether a conditional write operation for the given address is successful or failed. For example, in response to the conditional write operation associated with the given address being successful, the contention predictor may update the level of contention predicted for the given address to decrease likelihood of high contention prediction. In response to a failure of the conditional write operation associated with the given address, the contention predictor may update the level of contention predicted for the given address to increase likelihood of high contention prediction.

Another contention hint may be based on monitoring a period for which data allocated into a cache of the given processor remains resident in the cache before being subject to a snoop request received from the memory system. Snoop requests can be indicative of another processor trying to access the same cache line. If there is a long period between data for a given address being allocated into the cache and the data being snooped to cause a change of coherency state, then it is likely the level of contention is lower than when there is a shorter period between allocation and snooping. Therefore, in some examples, the processor-local contention predictor may update the level of contention predicted for a given address based on a snoop-away period between allocation of data for the given address into the cache and a snoop-triggered change of coherency state for the data for the given address from the cache due to a snoop request received from the memory system (that change of coherency state could be invalidation of the data for the given address, or downgrading of the coherency state from exclusive to shared, for example).

For example, one or more counters could be provided to count the period since allocation of the data, so that the snoop-away period can be monitored. When a snoop request is detected associated with a given address for which data is held in the cache, in response to the snoop-away period counted for the given address being less than a first threshold, the contention predictor may update the level of contention predicted for the given address to increase likelihood of high contention prediction, and in response to the snoop-away period being greater than a second threshold (the second threshold could be greater than or equal to the first threshold), the contention predictor may update the level of contention predicted for the given address to decrease likelihood of high contention prediction.

Some examples may train the contention predictor as a function of both these types of contention hint (conditional write success/failure rate and snoop-away period). There can be considerable flexibility to implement different control algorithms based on these input parameters.

Nevertheless, in general by considering such contention hints, a contention predictor local to a given processor can learn whether, for the current workload, it is more or less likely that a critical section in the thread running on the given processor may experience low or high levels of contention with other threads, which can help the processor to select whether the first or second processing behaviour is more likely to be beneficial for performance.

In one particular example, for cases where the read/write trigger is a read trigger, the control circuitry associated with a processor-local contention predictor may both control timing of issuing a coherence transaction issued in response to the read trigger, and control the target coherency state requested by that coherency transaction, based on the contention level prediction provided by the processor-local contention predictor for the target address associated with the read trigger. For example, in response to the read trigger, the control circuitry may:
in response to the processor-local contention predictor indicating a lower level of contention, issue, at a first timing prior to commitment of an instruction associated with the read trigger, a request for data corresponding to the target address to be read and allocated into the cache in a shared coherency state; and
in response to the processor-local contention predictor indicating a higher level of contention, issue, at a second timing later than the first timing, a request for data corresponding to the target address to be read and allocated into the cache in an exclusive coherency state. The second timing could be when any conditions required to be satisfied for the read trigger to be committed (other than return of the read data itself) have been resolved, so that the request for data to be read in the exclusive coherency state may be issued non-speculatively. Alternatively, the second timing could be in advance of the commit point, while at least one condition required to be satisfied for the read trigger to be committed is still to be resolved, so that the request for data to be read in the exclusive coherency state may still be issued speculatively, but as the second timing is later than the first timing then the request may be issued with lower speculation aggression when the level of contention is predicted to be higher than when the level of contention is predicted to be lower.
   This approach of controlling both request timing and coherency state based on the contention level prediction has been found from analysis of processing benchmarks to be particularly beneficial to performance.

In some examples supporting a processor-local contention predictor, the given processor may provide, to a home node configured to manage coherency between the cache of the given processor and a cache of at least one other requester, contention status information depending on the level of contention predicted by the processor-local contention predictor. For example, the contention status information could indicate information about the predicted level of contention detected by the processor-local contention predictor and/or further information such as information on a predicted duration of a critical section (which may depend on the predicted level of contention). Such contention status information could be used by the home node to manage contention between requests for access to the same address, e.g. by holding off coherence transactions for a given address for a longer time if the feedback from the processor-local contention predictor to the home node indicates that the level of contention is likely to be high for that address.

In some examples, the apparatus may comprise a home-node-local contention predictor associated with a home node configured to manage coherency between a plurality of caches associated with respective requesting nodes. Hence, the contention predictor could be provided at the home node which is responsible for managing coherency between multiple requesting nodes. The control circuitry (which may also be associated with the home node) may be configured to control, based on the level of contention predicted by the home-node-local contention predictor, a processing behaviour for processing a read/write request (e.g. read/write coherence transaction) received from a given requesting node. For example, the control circuitry may choose, depending on the level of contention predicted, whether to accept or reject a given read/write request. In some examples, the control circuitry may selectively introduce an additional delay in responding to a given read/write request when there is predicted to be higher contention (and select a shorter delay when there is predicted to be lower contention). Also, the control circuitry associated with the home-node-local contention predictor could adjust the coherency state in which data is returned to the given requesting node based on the predicted level of contention (e.g. in cases of high contention, returning data in an exclusive coherency state even if the corresponding request was for data in the shared coherency state, or returning data as a non-allocating read/write response so that data is effectively in the invalid coherency state for the requesters cache, even if the corresponding request was for data in the exclusive coherency state).

Hence, a home-node-based contention predictor can also help to improve performance for similar reasons to those given for the processor-based contention predictor, although with different examples of the read/write trigger which triggers the contention prediction and the contention hints used to train the predictor.

Regarding the contention hints used to train the home-node-based contention predictor, again a variety of opportunities are available for the home node to learn information at runtime about a current level of contention associated with access to a given physical address.

In some examples, the home-node-local contention predictor is configured to update the level of contention predicted for a given address based on detection of contention events when one requesting node requests access to a given address for which data is already held in a cache associated with another requesting node. For example, the home-node-local contention predictor can track a rate with which a request from one requesting node hits in a snoop filter against an entry for an address indicated as having data cached in the private cache of another requesting node, and update the home-node-local contention predictor based on that rate.

In some examples, the home-node-local contention predictor is configured to update the level of contention predicted for a given address based on a previous coherency state associated with data held in a first requesting node's cache for which the previous coherency state is changed to a different coherency state in response to a snoop request triggered by a request from a second requesting node to access the data associated with the given address. For example, when a second requesting node triggers a first requesting node to transition data held in a cache of the first requesting node from exclusive to shared coherency state or from any coherency state to invalid, the previous coherency state of the cached data may indicate whether the data was held in a clean or dirty state. If the previous coherency state indicates a clean state, then it is more likely that the data was snooped away from the first requesting node before the first requesting node completed its conditional write at the end of its critical section, indicating a likelihood of greater contention than if the data was held in a dirty state at the first requesting node (in which case it is more likely that a processor the first requesting node completed its critical section to update the data before the snoop request was received at the first requesting node).

In some examples, the home-node-local contention predictor is configured to update the level of contention predicted for a given address based on a frequency with which requests targeting the given address are received from the requesting nodes. For example, a measure of frequency of requests targeting a particular address can be obtained based on tracking the fraction of requests in a request queue that relate to the same address. If the frequency of occurrence of requests to a given address is relatively high, this can be a hint that there could be high contention of access to that address from multiple requesters, so information on the frequency of requests target a particular address can be used as a contention hint for training the contention predictor.

Some examples may provide at least one processor-local contention predictor, but no home-node-local contention predictor. Other examples may provide a home-node-local contention predictor, but no processor-local contention predictor.

However, some examples may comprise both at least one processor-local contention predictor and a home-node-local contention predictor.

In an example comprising contention predictors at both a home node and a processor, it can be useful for the home-node-local contention predictor to provide contention prediction feedback to a processor-local contention predictor associated with a given processor acting as one of the requesting nodes. The contention prediction feedback is dependent on a prediction of the level of contention by the home-node-local contention predictor for a given target address.

For example, the contention predictor feedback could be used by the processor-local contention predictor to prime its prediction data structure based on feedback received from the home-node-local contention predictor, which can help reduce prediction warm up times for the processor-local contention predictor.

Also, it can be particularly useful to share feedback on home-node-based contention predictions with the processor-local contention predictor in cases where the home-node-local contention predictor has predicted high contention for access to a given address and is successfully reducing system demand for access to that address by delaying responses to requests for the address. In this case, there can be a risk that, in absence of feedback from the home-node-local contention predictor to the processor-local contention predictor, the processor-local contention predictor may learn that contention for the given address appears to be low, even though contention is actually high but is artificially suppressed from the point of view of the processor due to the control of read/write processing behaviour (e.g. rejection or delay of read/write requests) selected based on the prediction by the home-node-local contention predictor. This could cause the processor to choose a processing behaviour aimed at improving single-threaded processing performance, which may not be preferred when there is actually high contention. In contrast, by considering the feedback information from the home-node-local contention predictor, the processor-local contention predictor may learn that contention is actually high (despite relatively few processor-local contention hints indicating high contention), so that an alternative second processing behaviour can be selected, which can help to conserve coherence transaction bandwidth on a memory system interconnect (since as discussed above, the second processing behaviour may speculate less aggressively and/or reduce the need for multiple coherence transactions requesting the same data in different coherency states).

Hence, providing feedback from the home-node-local contention predictor to the processor-local contention predictor can help manage available coherence transaction bandwidth more efficiently and improve prediction accuracy at the processor-local contention predictor in scenarios where actions taken by the home-node-local contention prediction may mean that predictions based purely on processor-local contention metrics may give a misleading representation of the actual level of contention.

As mentioned above, the contention predictor is configured to predict the level of contention based on looking up a prediction data structure based on at least the target address. A wide variety of techniques could be used to implement the prediction data structure.

In some examples, in response to detecting a miss in a lookup of the prediction data structure based on at least the target address, the contention predictor is configured to predict a lowest level of contention for access to data corresponding to the target address. This approach can be helpful to reduce the circuit area and power cost of the prediction data structure. It is likely that the number of addresses subject to high levels of contention will be much lower than the number of addresses subject to no contention or low levels of contention. Therefore, to conserve entries in the prediction data structure, it may be preferred to allocate prediction entries only for those addresses for which a level of contention higher than a given threshold is detected. It can then be assumed by default that if a given target address misses in the lookup of the prediction data structure, the given target address should be predicted to have the lowest level of contention.

In some examples, the prediction data structure could be looked up based on the target address only, e.g. by forming a lookup value as a function of the target address.

However, in some examples, the contention predictor may predict the level of contention based on looking up a prediction data structure based a lookup value derived from the target address and a program counter address associated with an instruction corresponding to the read trigger. For example, the lookup value could be performed by applying a hash function to the target address and the program counter address. By considering the program counter address as well as the target address, this can simplify access to the prediction data structure, as it is more likely that aliasing between multiple target addresses mapping to the same lookup value can be avoided if the program counter address is also considered, making it feasible to use a simpler direct-mapped cache structure to implement the prediction data structure rather than requiring the greater cost of a set-associative structure. This approach could be used at least for the processor-local contention predictor, as in cases where the read/write trigger is a given instruction to be executed by the processor, the program counter address of the instruction can be easily obtained. In cases where the contention predictor is a home-node-local predictor, consideration of the program counter address may be less likely but could still be possible if the processor can communicate to the home-node-local predictor a program counter address of an instruction associated with a given coherence transaction detected by the home node as the read/write trigger.

In some examples, a single table structure is provided as the prediction data structure, shared among both entries undergoing training, which have not yet reached a given level of confidence, and entries providing more confident predictions.

However, in some examples, the prediction data structure comprises a first table structure and a second table structure. When allocating a new entry in the prediction data structure for a given address for which confidence in prediction of the level of contention has not yet reached a threshold level of confidence, the contention predictor is configured to allocate the new entry in the first table structure. In response to a prediction of the level of contention for the given address reaching a threshold level of confidence, the contention predictor is configured to migrate the entry for the given address from the first table structure to the second table structure. By splitting the prediction data structure in two, with the first table structure for training and the second table structure for more stable entries, this can simplify replacement policy implementation. It may be preferable, when a new entry is required, to evict an entry undergoing training that is associated with a lower level of confidence, and prioritise retention of more stable entries associated with a higher level of confidence in predicting the level of contention. This approach can be simpler to implement if the stable entries are migrated to the second table structure, such that replacement decisions select a victim entry from the first table structure.

In some examples, the contention predictor may expose to software an indication of the predicted level of contention for at least one address. For example, the contention predictor could expose the predicted level of contention to a performance monitoring unit which provides software with performance monitoring metrics and other measurements of runtime parameters which could be useful for diagnosing performance issues with a given software workload. By exposing the predicted level of contention to software, this could help software developers better understand reasons for possible loss of performance in their workloads.

Specific examples are now described with reference to the drawings.

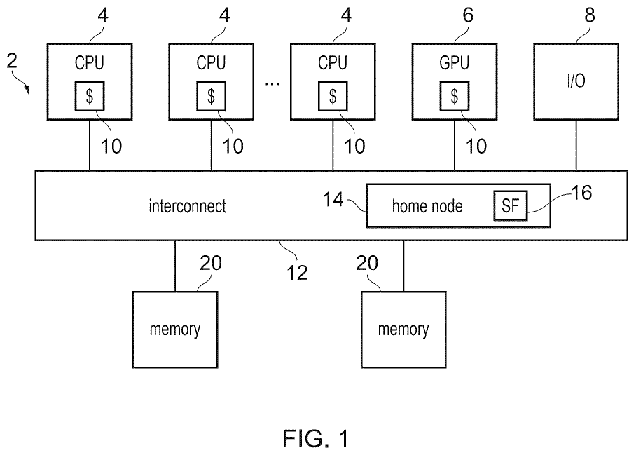

FIG. 1 illustrates an example of a processing system 2 comprising one or more memory access requesters 4, 6, 8. The memory access requesters include one or more processing elements capable of instruction execution. The processing elements include one or more central processing units (CPUs) 4 and can also include other types of processing element such as a graphics processing unit (GPU) 6. The memory access initiators can also include other non-processing-element memory access requesters such as an input/output (I/O) device 8. While FIG. 1 for sake of example shows three CPUs 4, one GPU 6, and one I/O device 8, it will be appreciated that the system 2 could include different numbers of requesters of a given type, could include additional types of memory access requesters not shown in FIG. 1 (e.g. a hardware accelerator) and may not necessarily include all of the types of memory access initiators 4, 6, 8 shown in FIG. 1. The memory access requesters 4, 6, 8 communicate with each other and with memory storage 20 via a system interconnect 12. Some of the access requesters (e.g. CPUs 4 and GPU 6) may have private caches 10 for caching data or instructions obtained from memory 20. The system 2 may also comprise a system cache which is shared between multiple requesters 4, 6, 8.

The interconnect 12 is responsible for routing requests between the requesters 4, 6, 8 and memory 20. The interconnect 12 is a coherent interconnect, comprising home node circuitry 14 which is responsible for maintaining coherency between cached data held at private caches 10 of a number of caching agents of the data processing system 2 (in this example, the caching agents are the CPUs 4 and the GPU 6, but other types of caching agents can be provided). The home node circuitry 14 implements a given coherency protocol, which defines a set of cache coherence transaction types and response protocols associated with those transaction types. Each address may, with respect to a particular caching agent, be considered to be held in that caching agent's private cache 10 in a particular coherency state. For example, the coherency state may specify, with respect to a given address and a given caching agent 4, 6, whether valid data for that address is held at the given caching agent's private cache 10, and if valid data is held, whether that data is clean or dirty, and/or is held in an exclusive (unique) or shared state (exclusive data being held exclusively in that caching agent's private cache 10, and not in other caching agent's private caches 10, while shared data is capable of being held in private caches of two or more caching agents simultaneously). When data is held in an exclusive state, the caching agent holding the data as exclusive is allowed to write to the data in the cache without first issuing coherence transactions to check with the home node 14 whether other caching agents could also be holding the data. When the data is held in a shared state, any write to the shared data in a given caching agent's private cache would require first issuing a coherence transaction to check with the home node 14 whether there are conflicting copies in other caches 10 (e.g. that coherence transaction may typically be a request that the data in the given caching agent's private cache 10 is upgraded to the exclusive coherency state, which may cause the home node 14 to send snoop requests to any other agents holding that data to trigger invalidation of data from those caching agents' private caches 10).

The home node circuitry 14 also manages any system level cache (SLC) or last-level cache (LLC), which is a shared cache, shared between each of the requesters 4, 6, 8, and is also part of the coherency scheme managed by the home node circuitry 14. The SLC/LLC can be updated (e.g. by far atomic operations) without having to bring the cache line to a processor in the exclusive state.

The coherency protocol may require that certain coherence transaction types or responses to such transactions may be associated with certain transitions of coherency state for cached items of data associated with the target address of the request. When a read/write coherence transaction is received from one of the caching agents 4, 6 requesting a read/write operation to a given physical address, the home node circuitry 14 issues snoop requests to one or more other caching agents 4, 6 that could potentially hold valid cached data for that physical address. A snoop request may query the current coherency state of the cached data for a specified address at a corresponding caching agent, and/or trigger changes in coherency state at the caching agent. For example, a change of coherency state triggered by a snoop request could include any of: invalidating cached data if the requester of the original read/write request requires the data to be cached in the unique state in its cache; causing return of dirty data held in a snooped caching agent's cache 8 so that the dirty data can be made accessible to the requester which sent the read/write request; and/or downgrading the coherency state of cached data for the specified address from exclusive to shared.

As shown in FIG. 1, the home node circuitry 14 may be associated with a snoop filter 16 for tracking (at least partially) which data addresses are cached at certain caching agents 4, 6. The snoop filter 14 can be used to reduce snoop traffic by allowing the home node circuitry 14 to determine when data is not cached at a particular requester. In the absence of snoop filtering, when one requester 4, 6 issues a read or write transaction to data which could be shared with other caching agents, the home node circuitry 14 may cause snoop requests to be issued to each other caching agent which could have a cached copy of the data from the same address. However, if there are a lot of caching agents, then this approach of broadcasting snoops to all cached requesters can be complex and result in a large volume of coherency traffic being exchanged within the system 2. By providing a snoop filter 16 which can at least partially track which addresses are cached at the respective caching agents 4, 6, this can help to reduce the volume of snoop traffic, enabling more efficient use of available request bandwidth and improving system performance. Often, it can be infeasible to implement a precise snoop filter scheme exactly tracking the addresses stored at each caching agent 4, 6, as such precision may be unacceptably expensive in terms of the storage and bandwidth cost. Therefore, the snoop filter 16 may track the content of the caches imprecisely. Provided there are no false snoop suppression instances where data actually held at a given private cache 10 is mistakenly identified as not present so that snoops to that given private cache 4, 6 are incorrectly suppressed, it can be permitted to use a less precise tracking scheme which permits cases where the snoop request is issued to a given caching agent but (due to lack of precise information) that caching agent actually does not hold a valid copy of the data for the address specified in the snoop request (e.g. a processor 4 may have silently invalidated a local copy of the data without informing the home node 14). In some examples the snoop filter 36 may be combined with the system level cache, with a single structure looked up based on an address providing both cached data and snoop filter information associated with that address.

It will be appreciated that FIG. 1 is merely a simplified representation of some components of a possible processing system, and the system could include other elements not illustrated for conciseness.

In a system comprising multiple processors 4 with coherent access to shared memory, one type of software workload which may be executed on the processors 4 may be a shared memory function where multiple software threads need to perform atomic read/modify/write updates on shared data in memory. For example, a sequence to be performed by each thread may include a read of a shared memory location, one or more operations dependent on the read data to generate a modified value, and a write of the modified value to the shared memory location. To illustrate the danger of synchronisation errors when multiple threads contend for updates to shared data, consider an example where such a read/modify/write sequence is used to update a bank account balance in response to a request to transfer money to the account. The read/modify/write sequence could therefore be something like the following:
read the memory location representing the account balance of the required bank account;
add the transferred amount to the account balance to generate a modified account balance;
write the modified account balance back to the memory location representing the account balance of the required bank account.
   As a bank may be processing a high rate of transfer requests, to improve processing performance it can be desirable to parallelize multiple updates by executing a number of threads on multiple CPUs 4 of the processing system 2, each comprising the above read/modify/write sequence. On many occasions, the transfer requests processed in parallel may relate to different bank accounts and so there is no contention. However, there is a risk that if two threads process respective transfer requests for the same bank account in parallel, if the read/modify/write sequences for processing those transfer requests overlap and the software is written poorly without any measures enforcing synchronisation of the corresponding updates, this could lead to a synchronisation error in the following scenario:

| Thread 1 | Thread 2 |
|---|---|
| Read balance of memory location X | |
| e.g. balance[X] = 1000 | |
| Add transferred amount 1 to balance | Read balance of memory |
| to generate modified balance 1 | location X |
| e.g. 1000 + 200 = 1200 | e.g. balance[X] = 1000 |
| Write modified balance 1 to memory | Add transferred amount 2 to |
| location X | balance to generate modified |
| e.g. write 1200 to balance[X] | balance 2 |
| | e.g. 1000 + 40 = 1040 |
| | Write modified balance 2 to |
| | memory location X |
| | e.g. write 1040 to balance[X] |

Here, as the read for thread 2 occurred between the read and write operations for thread 1, this means the read for thread 2 did not take into account the modified balance (1200) written by thread 1, and so the subsequent write of modified balance 2 by thread 2 causes the end result to be that the balance in account X is set to 1040. This overwrites modified balance 1=1200 written by thread 1, effectively causing the transferred amount 1 (e.g. £200) to be lost. The final balance shown by memory location X does not consider the transferred amount 1 even though thread 1 seems to have finished processing the request to transfer amount 1 to the bank account. Hence, the owner of the account may find they have lost money that they were entitled to.

Hence, this kind of synchronisation error can have serious consequences for some processing workloads. It will be appreciated that the above example is just a simplified example for illustrating the problem, and in practice many shared memory functions may be considerably more complex than the example shown above, e.g. involving updates to multiple locations and with more complex modification sequences between the initial read and the write.

To avoid such synchronisation error, software developers may write the program code for threads to include a “critical section” which is to be observed as executing atomically (indivisibly). For example, the critical section can include the read, add, write sequence of the example shown above. A number of techniques can be used to ensure atomic access to the shared memory location. For example, a lock variable may be used to negotiate exclusive access to the shared memory location, with a given thread not entering the critical section until it has acquired the lock for the shared memory location. However, lock-based techniques may be slow, and other non-locking techniques are possible, which allow each thread to start processing the critical section without first acquiring a lock, but may ensure synchronisation by, for example, making the final write operation of the critical section conditional on a condition which will fail if another thread has written to the shared memory location X in the period between the read and write.

For example, a compare-and-swap operation may be used to implement the final write, with the write being conditional on a comparison between a value re-read from memory location X in response to the compare-and-swap operation and a compare value which corresponds to the previously read value at the start of the atomic sequence. This can cause the critical section to fail (and not implement the final write) if the value at memory location X has changed during processing of the critical section. For example, in the above example, a compare-and-swap implementing the write for thread 2 would find that the current value for location X (1200) does not match the value (1000) read earlier in the critical section, so the write could be suppressed and the critical section of thread 2 repeated based on the latest value read from the memory location.

An alternative to using compare-and-swap may be to use a load-exclusive instruction to perform the initial read (which in addition to loading the read data for location X will also cause an exclusive monitor to be set for location X). A store-exclusive instruction can then perform the final write back to location X. A store-exclusive instruction causes the write to location X to be made conditional on the exclusive monitor still being set for location X. Intervening snoop requests between the load/store exclusive instructions (which are an indication that other requesters have accessed location X) will cause the exclusive monitor to be cleared for location X so that a subsequent store-exclusive to location X would fail its condition. A loop can be included in the thread software to ensure that following a failed conditional write, the critical section is tried again.

These are just some examples of possible techniques for implementing critical sections. It will be appreciated that there are a wide variety of software techniques which can be used to implement such critical sections with protective measures to ensure atomic updates to the shared data, so the techniques discussed below are not limited to any particular technique for implementing such atomic updates.

Hence, in general the critical section starts with a read of the memory location and ends with a conditional write to the location. If critical sections may seem to overlap between threads (e.g. many threads/processors can read a location and have the cache line in shared state at the same time), only one thread will succeed with the corresponding update and other threads will have to restart their critical sections.

The aggregated update rate across a set of threads is dependent on the length of the “critical section”. The longer the critical section, the greater the probability that threads seeking to access the same shared data will overlap their critical sections and so conflict for access, leading to a requirement to restart critical sections in all but one of those contending threads. If the critical section is shorter, the probability of overlap is lower and the aggregate update rate of the shared location (cache line) is likely to be higher.

However, the inventors recognised that a given processor 4 may implement read/write processing strategies aimed at improving performance of a single thread which may sometimes harm the aggregated update rate of a shared location when highly contended by multiple threads. Loads are usually speculated (e.g. with load requests issued based on speculation due to, for example, branch prediction, value prediction, address predictions or prefetch predictions, before it is known whether a load to the requested address is architecturally required by the program being executed). Based on the speculation, the corresponding cache lines can be fetched early and cached in a shared state in one or more caches. Acquiring a shared copy of a line also downgrades any unique copy held by other requesters' private caches 10 to shared state. Speculating loads is good for single-threaded performance (hiding cache miss and interconnect latencies) but hurts aggregated update rate, because the early allocation of the data into a private cache effectively extends the overall duration of the critical section. Hence, if each CPU 4 running the threads of the shared memory update process uses this strategy (aggressively speculating on loads and requesting the data early in a shared state), the increased length of the critical section on each CPU 4 may increase the probability that critical sections on multiple threads overlap when seeking to access the same shared data, which is likely to harm performance overall.

To minimise the critical section, an alternative strategy is for the CPU 4 executing a given instance of a critical section to fetch the targeted cache line in unique state (in order to avoid shared copies) and to fetch the cache line as close as possible to when the update will occur. This will minimise the critical section and thus improve the aggregated update rate and system scalability. However, the downside is that single-threaded performance may be hurt since speculative execution based on the value returned by the memory read will be limited.

Similarly, for some write requests, the processor may speculate on the write and issue an early request to bring data for the target address into the private cache 10 in an exclusive coherency state, which may in some cases prolong the critical section and cause similar problems as discussed above for reads. In cases of high contention, the aggregate update rate of critical sections on multiple CPUs 4 may be higher if the write was speculated less aggressively, to delay the write coherence transaction, and/or if the write was processed using a non-allocating write request which triggers the update to the data for the target address (e.g. in a shared system level cache) without causing allocation of the data into the private cache 10 of the processor 4 requesting the update.

Thus we have a conflict between optimizing for single threaded performance (speculate as early as possible) and optimizing for multithreaded scalability (minimize critical section by late coherence transactions and adjusting the coherency state in which the data is requested).

However, it can be difficult for software developers to know in advance whether there is likely to be high or low contention for access to the shared data, as this depends on runtime factors such as the number of threads selected to be executed in parallel on respective processors 4, the relative timing at which respective threads start their critical sections, and data-dependent factors such as properties of the data set being processed (e.g. if the shared location to be updated atomically is selected from a set of shared locations based on each item of data read by respective threads from a data set, the likelihood of contention may depend on the distribution of within the data set-if the data set has a high frequency of occurrence of a given data value then contention may be larger than if the data items are more evenly distributed across different data values).

In the examples discussed further below, a contention predictor 32 is provided to provide runtime predictions of the level of contention expected for access to a particular physical address to be read/written, so that a read/write processing behaviour can be selected based on the predicted level of contention. This allows average case performance to be improved as in cases of predicted low contention the priority may be to improve single-threaded performance in preference to multi-threaded performance, while in cases of predicted high contention single-threaded performance may be sacrificed to improve collective performance for multiple threads.

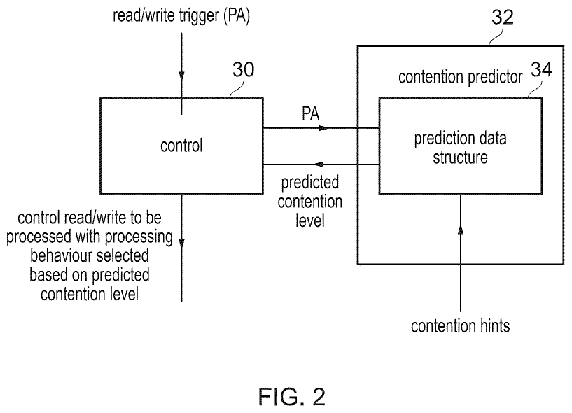

FIG. 2 illustrates an example of a contention predictor 32 and control circuitry 30, which, as noted in more specific examples shown below, can be included at various parts of the processing system 2 (e.g. at a processing element 4 and/or at the home node 14). The control circuitry 30 receives a read/write trigger indicating that a read or write is requested (or is predicted to occur in future) for a specified target address (physical address, PA). Depending on the point of the system 2 at which the control circuitry 30 is implemented, the read/write trigger could be, for example, detection that an instruction is to be executed which is of an instruction type which would require a read/write request to be issued to the cache or memory, a prefetch prediction that the target address is likely to be accessed in future, or receipt of a coherence transaction specifying the target address at the interconnect 12.

In response to the read/write trigger, the target address is looked up in a prediction data structure 34 provided by the contention predictor 32, which returns a corresponding prediction of a level of contention for access to data corresponding to the target address. For example, the level of contention could be selected from two possible levels (high contention and no/low contention), or could be expressed as one of three or more different levels of contention, depending on implementation choice. As there are likely to be many more addresses subject to no contention or low levels of contention than addresses subject to high contention, the default could be that in the event of a physical address missing in the prediction data structure 34 (i.e. the prediction data structure 34 does not contain any valid entry corresponding to the looked up address), the contention predictor 32 may predict the lowest possible level of contention by default.

The prediction data structure 34 can be trained based on contention hints detected by the contention predictor 32 which may hint towards possible higher or lower contention between multiple requesters contending for access to the same physical address. Various examples of such contention hints are discussed in more detail below.

Based on the returned prediction of the contention level, the control circuitry 30 selects a processing behaviour to be used for processing the read/write trigger. For example, based on the level of contention predicted by the contention predictor, the control circuitry 30 can select one of: a first processing behaviour which prioritizes improving single-threaded processing performance over multi-threaded processing performance; and a second processing behaviour which prioritizes improving multi-threaded processing performance over single-threaded processing performance. Other examples may support more than two alternative processing behaviours, selecting between three or more alternative processing behaviours based on a prediction expressing one of three or more levels of contention. In general, the processing behaviours may differ in the level of speculation aggression associated with speculatively processing the read/write trigger, the particular timing at which the read/write trigger is processed, and/or a coherency state in which data is requested to be cached in response the read/write trigger. By varying these parameters, the control circuitry 30 can select the extent to which critical sections are shortened (in cases of high predicted contention) or lengthened (in cases of low predicted contention), to provide improved average case performance because in cases of low or no contention the prioritisation of single-threaded performance will tend to benefit the overall update rate achieved in the critical sections executed across multiple threads, while in cases of high contention the prioritisation of multi-threaded performance will tend to benefit the overall update rate achieved in the critical sections executed across multiple threads. In particular, it has been shown by benchmarking that when the shared location is highly contended, using operations optimized for multi-threaded performance provides approximately double the update rate compared to optimizing for single-threaded performance, so it is expected that considering contention predictions to select processing behaviour will greatly benefit the average case processing performance compared to approaches which always select either the first processing behaviour or the second processing behaviour by default.

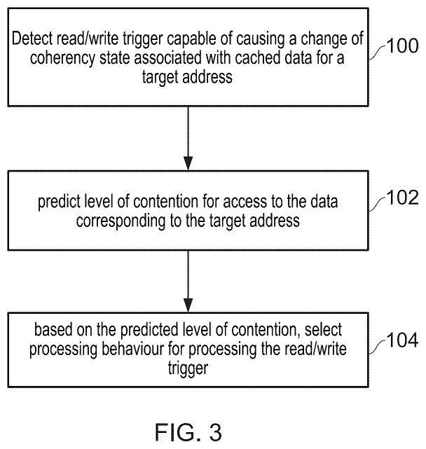

FIG. 3 illustrates a method using contention predictions. At step 100, the control circuitry 30 detects a read/write trigger capable of causing, with respect to a given private cache 10, a change of coherency state for data corresponding to a target address. At step 102, the contention predictor 32 predicts, in response to the read/write trigger, the level of contention for access to the data corresponding to the target address. At step 104, the control circuitry 30 selects, based on the predicted level of contention, a processing behaviour for processing the read/write trigger.

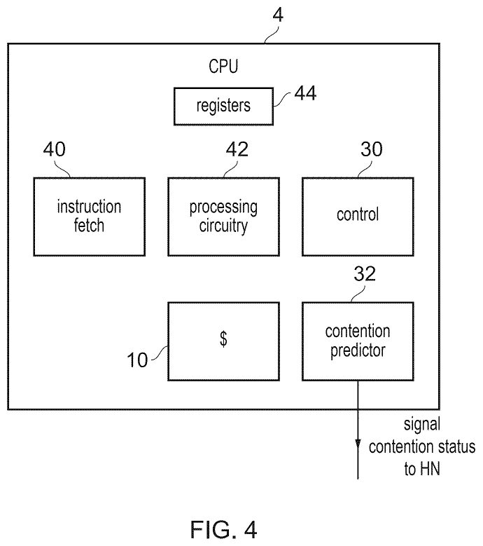

FIG. 4 illustrates a more specific example in which the control circuitry 30 and contention predictor 32 are provided within a given processor (e.g. CPU) 4, such that the contention predictor 32 is a processor-local contention predictor. The processor 4 includes instruction fetch circuitry 40 which fetches instructions from an instruction cache or memory for execution by processing circuitry 42. The processor 4 also has registers 44 for storing operands for the executed instructions and results generated by the processing circuitry 42 in response to executed instructions. The processor 4 has at least one private cache 10 as mentioned earlier, and also includes the control circuitry 30 and contention predictor 32 described above with respect to FIGS. 2 and 3.

In the case where the contention predictor 32 is a processor-local contention predictor provided at a given processor 4 of the system 2, the read/write trigger could, for example, be a particular instruction encountered by the processing circuitry 42 that is of an instruction type that will require a read/write to a particular target address. The particular stage of a processing pipeline at which the read/write trigger is detected may vary, e.g. depending on when address operands defining the address to be accessed by the instruction become available, and also on whether the contention predictor 32 is looked up based on a virtual address or physical address. If the contention predictor 32 is looked up based on a physical address then the read/write trigger may not be considered to have been detected until the address translation to obtain the physical address has been performed.

Various instruction types could be detected as examples of a read/write trigger instruction which may trigger a lookup of the contention predictor 32. For example, some instruction types that can be used in critical sections for atomic read/modify/updates to shared memory, which can be detected as a read trigger instruction, can include:
prefetch-for-store instruction: an instruction which provides a prefetch hint which can selectively be ignored by the hardware, but if not ignored causes a coherence transaction to be issued which requests that data associated with a target address is prefetched into the processor's private cache 10 in an exclusive (unique) coherency state, ready for a subsequent store operation to be performed on the loaded data. Unlike a load instruction, the prefetch-for-store instruction does not require the loaded data to be allocated to any register 44.
load instruction: a general purpose load instruction which requests that data associated with a target address is loaded to a target register 44 (and which will typically also cause that data to be cached in the private cache 10, if the data is not already held in the cache 10).
load-exclusive instruction: a special kind of load instruction which, in addition to the load operation described above, also causes setting of an exclusive monitor indication associated with the target address (the exclusive monitor indication being an indication which is cleared on detecting a conflicting access to the target address based on a snoop request triggered by external accesses to the same data, and which is checked when executing a corresponding store-exclusive instruction so that the write to a target address of the store-exclusive instruction is performed conditionally, such that the write is successful if the exclusive monitor indication still being set for that address but fails if the exclusive monitor indication is not set for that address).
identity-compare-and-swap (identity CAS or ICAS): a compare-and-swap instruction for which the compare operand (to be compared with the value at a target address to determine whether a comparison condition is satisfied) and the swap operand (to be written to the memory location corresponding to the target address if the comparison condition is satisfied) are identical to each other. While a CAS instruction would normally be regarded as a conditional write instruction (in cases where the swap operand differs from the compare operand), in cases where compare and swap operands are identical, the ICAS essentially behaves as a load instruction (loading the value at the target address and not changing the value in memory). Some software developers or compilers may therefore use an ICAS as a load at the start of a critical section (e.g. exploiting the otherwise redundant encoding of an ICAS to give additional hint information which is not to be provided for regular loads). Therefore, ICAS instructions could also be detected to be a read trigger which triggers a lookup of the contention predictor 32.

Similarly, instruction types that can be detected as a write trigger could include a store instruction (general purpose store instruction which requests that data associated with a target address is updated based on store data obtained from a target register), prefetch-for-store instruction, store-exclusive instruction, or (non-identity) compare-and-swap instruction.

If the processor 4 has prefetch circuitry for making prefetch predictions of future addresses expected to be accessed by future instructions processed by the processing circuitry 42, another example of a read/write trigger could be a prefetch prediction made by the prefetch circuitry, that indicates that a prefetch request may be generated for a given target address (even if no instruction specifying the given target address has yet been detected).

In the case of a processor-local contention predictor, there are a variety of contention hints that can be used to train the contention predictor. In general, a contention hint may be any event, measurement or signal that gives at least an approximate indication of increased or decreased likelihood that there may be low or high contention.

One example of a contention hint may be a success/failure indication associated with a conditional write instruction. The success/failure indication may indicate whether the condition governing whether a conditional write to a target memory address is carried out is satisfied or not satisfied. For example, a conditional write instruction could be a (non-identity) compare-and-swap instruction or a store exclusive instruction as mentioned above. Failure to write the memory location (e.g. CAS comparison failure, STXR failure) may indicate high contention (e.g. some other thread modified the location between this PE's read and write operations) and so the contention predictor 32 may be updated to set the contention entry value associated with the target address of the conditional write instruction to indicate higher probability of contention (e.g. a confidence indication in a high contention prediction could be adjusted to indicate increased confidence in the prediction of high contention).

On the other hand, if a conditional write instruction satisfies the condition governing the write (the write is successful), this is an indication of lower likelihood of high contention for the corresponding address. If the memory location is updated successfully, the contention predictor 32 could be updated to indicate lower probability of contention. Even if the current contention prediction is correct, it could be overly cautious (if contention was previously higher for that address), so the contention confidence (or other contention value) could be slightly decreased on a successful write to memory in order to handle potential decreasing contention. However, it may be undesirable to get periodic failures because the predictor value is decreased on every successful write and eventually but incorrectly signifies low contention, so a control loop can be implemented that provides a more balanced trade-off (e.g. probabilistically updating the contention predictor value to decrease likelihood of high contention prediction only on a given fraction of instances when the conditional write instruction is successful).

Another contention hint that could be exploited is the “snoop-away” time associated with data for a given address allocated in the private cache 10 of the processor 4. The snoop away time is the time between the data first being allocated into the cache 10 and the time when a downgrading of coherency state (e.g. invalidation, or downgrading from exclusive to shared coherency state) is triggered by a snoop request being received from the interconnect 12 triggered by an access to the same cache line by another requester 4, 6, 8. If a cache line whose address is present in the contention predictor is quickly snooped away/invalidated or downgraded from exclusive to shared, the corresponding entry of the contention predictor's prediction data structure 34 can be updated to increase likelihood of prediction of high contention for that address. If the line is snooped away some time after the processor's own update at the end of the critical section, this indicates low contention and the contention indicator could be updated to decrease probability of predicting high contention for the corresponding address. Hence, if the snoop away time is less than a first threshold, the probability of high contention prediction can be increased, and if the snoop away time is greater than a second threshold (greater than or equal to the first threshold), the probability of high contention prediction can be decreased. The first and second thresholds could be dynamically decided, or could be set statically.

In some examples, a balance can be reached by successful conditional writes decreasing the likelihood of high contention prediction and quick snoops/invalidations of the same line increasing the likelihood of high contention prediction (if present in the contention predictor).

More generally, the predictor control loop could be any control loop which has conditional write success/failure status and/or line snoop away time (both before and after the conditional write) as inputs. It will be appreciated that other types of contention hint could also be used.

If, on updating the contention predictor 32 based on a contention hint such as conditional write success/failure or snoop away time, the prediction data structure 34 does not already include an entry corresponding to the target address associated with the contention hint, a new entry can be allocated and inserted with a value that matches the particular contention hint detected (e.g. indicating high contention if the conditional write failed or a short snoop away time was detected, and indicating low contention if the conditional write was successful or a long snoop away time was detected). Entries in the contention predictor which are no longer accessed can be aged out of the predictor. They can be explicitly removed or replaced by newer entries (e.g. according to a least-recently-used mechanism).

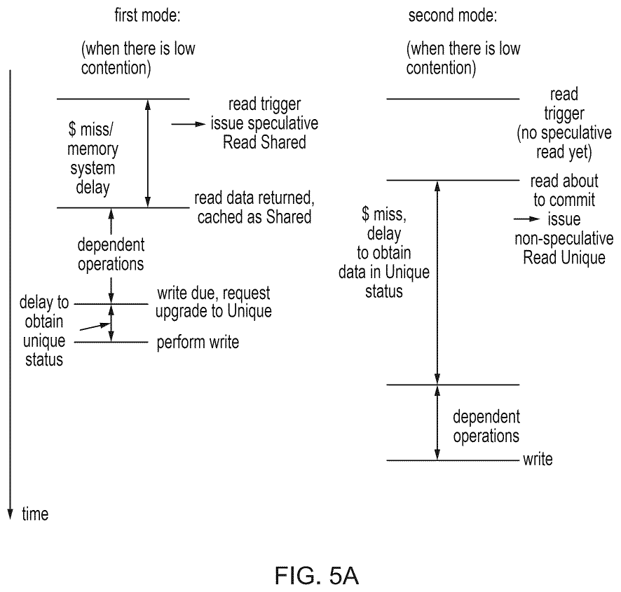

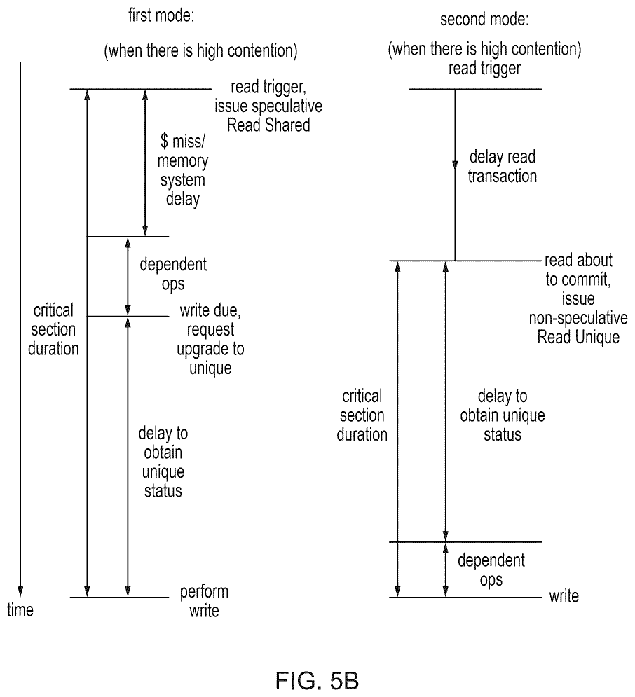

FIGS. 5A and 5B illustrates an example of alternative read processing behaviours which can be selected by the control circuitry 30 based on the contention prediction provided by the contention predictor 32, contrasting the relative performance of these read processing behaviours in the case of low contention (FIG. 5A) and high contention (FIG. 5B). In this specific example, the read/write trigger is a read trigger (e.g. any of the examples of read trigger mentioned earlier).

The left-hand portion of FIG. 5A illustrates a first mode selected by the control circuitry 30 in cases where the predicted level of contention is low. In this example, in response to the read trigger being detected, a speculative “ReadShared” coherence transaction is issued requesting that the data for the required target address is cached in private cache 10 in a shared coherency state (a state in which multiple requesters' private caches 10 are allowed to simultaneously cache data for the same address, but modification of data held in the private cache 10 for that address would require the processing element 4 to issue a further request to the home node to negotiate transition to the “unique” state before performing the write in the private cache 10, to enforce invalidation of corresponding copies held in other requesters' private caches 10). By issuing the ReadShared early (speculatively, while still awaiting resolution of whether the instruction or prefetch prediction associated with the read trigger has been correctly issued), the subsequent delay in obtaining the read data for the target address and allocating it into the private cache 10 can be overlapped with any delay in resolving speculation associated with the read trigger. As such speculation resolution delays may be considerable (given that modern processors may speculate far beyond the last committed instruction based on branch prediction, for example) and also the cache miss/memory system latencies in obtaining the data can be considerable in cases where the data is not already cached in the private cache 10, overlapping the speculation resolution and cache miss/memory system latencies can provide a significant performance benefit in performance for a single thread, as this can allow any dependent operations performed on the read data and the final write that terminates the critical section to be processed earlier.

Once the read data has been returned and allocated into the private cache 10 in the “Shared” coherency state, the dependent operations performed to implement the “modify” part of a read/modify/write sequence can be performed. Prior to the final write, a “ReadUnique” request (or similar coherence transaction) which request upgrading of the read data from Shared to the Exclusive (Unique) coherency state is issued to the home node 14. The processing element 4 awaits a response from the home node 14 confirming the granting of unique status. The delay in receiving that response may depend on how many other requesters' private caches 10 hold shared copies of the same cache line—if there are a greater number of requesters' holding the data, there is likely to be a greater delay in the home node 14 snooping those other requesters and receiving snoop responses from each of those requesters confirming invalidation of any Shared copies of the cache line to be held as “Unique” by the requester which issued the ReadUnique request. In the example of FIG. 5A, there is low contention, and so the home node 14 may not need to issue many snoop requests, so the delay in obtaining “Unique” status can be low. Once the Unique (Exclusive) coherency state has been assigned to the data held in the private cache 10 of the requester that issued the ReadUnique request, and any dependent operations for generating the modified value to be written in the final conditional write to the cache line are also complete, the final conditional write can be performed, successfully completing the critical section.

On the other hand, the right-hand portion of FIG. 5A illustrates a second mode for read processing behaviour, again in the case of low contention. In this case, in response to the read trigger, no speculative read request is issued yet, and instead the control circuitry 30 waits until nearer the point when the read trigger is committed (any speculation associated with the read trigger is resolved) before issuing the read coherence transaction to the interconnect 12 to request reading of the data for the shared memory location from memory and allocation of the data into the cache. In this example, the read request is deferred until the read trigger is about to commit (e.g. commitment of the read trigger is no longer waiting on any other condition other than return of the read data) and is then issued non-speculatively. For example, if the read trigger is an instruction, the read request can be issued when the instruction is actually about to commit; or if the read trigger is a prefetch prediction, the read request can be issued when a corresponding demand load for the corresponding address is actually detected (in other words, the initial prefetch prediction detected as the read trigger can be ignored and any prefetch request based on the prefetch prediction may be suppressed, with the control circuitry 30 instead waiting for an actual demand load instruction to be executed, before issuing any coherence transaction. While FIG. 5A shows an example of issuing the read request non-speculatively when the read trigger is about to commit, other examples might, in the second mode, still issue the read request speculatively, but issue it at a later timing than in the first mode, so that the read request is issued closer to the point when the read trigger is committed than in the first mode shown in the left hand part of FIG. 5A.

Also, rather than initially requesting the data in the Shared coherency state and then later upgrading to Unique state as in the first mode, in the second mode the initial read requests to request access to the shared location is a ReadUnique request that requests that the data is allocated into the private cache 10 in the Unique coherency state. Again, once the data has been obtained (this time in the Unique state), the dependent operations for modifying the data and the final conditional write can be performed. As the data is obtained Unique from the outside, it is more likely that the write can be performed immediately after the dependent operations are complete, rather than needing further negotiation with the home node.

Hence, in cases of low contention, the most significant contribution to delay in a given thread executing the critical section is likely to be the cache miss and memory system delay associated with the initial read of the shared data, and so overall latency for a single thread can be shortened by speculatively issuing that read request as early as possible as in the first mode. The subsequent delay to obtaining “Unique” status just before the write may be less significant in cases of low contention, so that, for low contention it is likely that, as shown in FIG. 5A, the first mode will give better performance than the second mode.

In contrast, FIG. 5B shows the same two read processing behaviour strategies, in cases of high contention. In this case, if the first mode is selected, the delay to obtain the Unique status just before the final write of the critical section is likely to be much longer, negating the benefits of the early speculative ReadShared request. See how in comparison to FIG. 5A, the overall latency is longer in FIG. 5B for the first case. Even worse, if many processors 4 running respective threads have all selected the first mode and are contending for access to the same location, pulling the read coherence transaction issued in response to the read trigger earlier in time will have effectively extended the overall duration of the critical section on each of those processors 4, making it much more likely that a greater number of threads have overlapping critical sections, and hence exacerbating the delay associated with obtaining the Unique coherency state for the shared data, because there will be additional snoop request/response sequences to execute with respect to each sharer of the same data, increasing the upper bound in response time. The first mode will also cause much interconnect bandwidth and home node request processing capacity to be wasted in processing useless “ReadShared” transactions issued speculatively, which are not useful because the data read in the “shared” coherency state is subsequently invalidated due to a contending thread obtaining the same data in the Unique state. This waste of bandwidth can greatly exacerbate the performance cost of the first mode in cases of high contention, as the useless ReadShared requests may enter interconnect queues where they may block other requests from being processed, harming the overall rate at which the collection of threads as a whole can update the shared variable in memory and more generally harming processing performance in the processing system 2 as a whole.

In contrast, in the second mode, the bandwidth occupied on the interconnect 12 and at the home node 14 by the set of executing threads is greatly reduced because all the ReadShared requests are eliminated by switching to a mode which initially requests the data as “Unique”, freeing up interconnect capacity for handling more useful requests. Also, the number of snoop responses awaited by the home node 14 before confirming to a given processor 4 that it has been granted Unique status will tend to be lower, because deferring the initial read coherence transaction sent in response to the read trigger tends to reduce the overall window of the critical section (as shown in the right hand part of FIG. 5B, the critical section duration is now from the time when the read coherence transaction is actually sent, not from the time the read trigger is detected). The shorter critical section duration achieved by selecting the second mode will tend to decrease the average number of threads which will be in conflict at a given time, hence further reducing the likely maximum bound on delay associated with the negotiation of the “Unique” coherency state before completing the write at the end of the critical section.

Therefore, the multi-thread mode can greatly improve performance in the case of high contention (but if selected when there is actually low contention could harm performance as in the more usual case of low contention speculating more aggressively is faster). This illustrates why providing runtime predictions of contention level can be particularly powerful in enabling better average case performance when executing shared memory update functions involving atomic read/modify/write sequences.

While FIGS. 5A and 5B shows an example where the control circuitry 30 selects between two alternative read processing behaviours based on the contention prediction, other examples could support more than two alternative read processing behaviours. For example, in addition to behaviours associated with the two extremes shown in FIGS. 5A and 5B, one or more additional read behaviour modes may be supported providing intermediate timings for the initial read request of the critical section (with the read still issued speculatively, but not waiting until as close to commitment of the read trigger), such that successively higher levels of contention predicted by the contention predictor may cause the control circuitry 32 introduce successively greater delays in issuing the read coherence transaction (with implementation choice as to the threshold level of contention at which the read coherence transaction is switched from ReadShared to ReadUnique). By supporting additional read processing behaviours, this can give more fine-grained choices which may provide greater overall update throughput in cases of intermediate levels of contention. However, in many implementations a simple binary choice of read processing mode may be enough to give a significant average case performance improvement over a system not supporting any contention prediction at all.

FIGS. 5A and 5B show an example of adapting read processing behaviour selected in response to a read trigger, based on the level of contention predicted by the contention predictor 32. However, it is also possible to adapt write processing behaviour selected in response to a write trigger, based on the level of contention predicted by the contention predictor 32. For write triggers, the first mode may comprise issuing a coherence transaction corresponding to the write trigger at an earlier timing (e.g. with more aggressive speculation) and the second mode may comprise issuing a coherence transaction corresponding to the write trigger at a later timing (e.g. with less aggressive speculation or issuing the coherence transaction non-speculatively). Also, the coherency state in which the target data is requested may vary depending on which mode is selected. For example, in the first mode the data may be requested or returned in the exclusive state, but in the second mode the data may be requested or returned in an invalid state, so that the request is effectively downgraded to a non-allocating write operation. By selecting the first mode in cases of low predicted contention and the second mode in cases of high predicted contention, this can similarly improve the aggregate performance of contending threads in the average case.

In an example where the contention predictor 32 is based at the processor 4, as shown in FIG. 4 the contention predictor 32 may signal contention status information to the home node 14, which can be used by the home node 14 to further improve management of contention for access to the same data. For example, information on the likely level of contention (or other related information such as predicted duration of a critical section) can be used to prepare the home node that the location (cache-line) being used to guard a critical section (using any of the mechanisms already mentioned above) will likely be available after a particular period. The home node 14 can then use this information to better hold off contending PEs for an appropriate delay and avoid unnecessary coherency traffic which would otherwise get blocked in the interconnect 12, to improve the throughput of the critical sections.

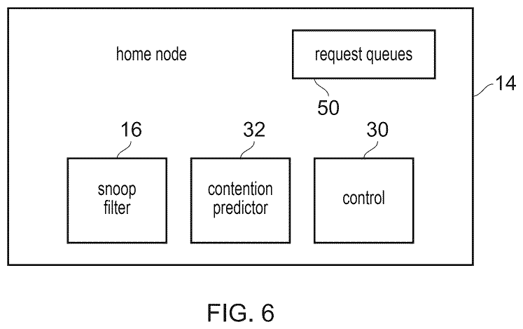

As shown in FIG. 6, an alternative location for a contention predictor 32 can be within the home node circuitry 14. The home node circuitry 14 may comprise a snoop filter 16 used to track (precisely or imprecisely) coherency states associated with data allocated in private caches 10 of respective requesters, and comprise one or more request queues 50 used to queue coherence transactions awaiting processing. The home node circuitry 14 also comprises the contention predictor 32 and the control circuitry 30 described earlier with respect to FIG. 2.

In the case of a home-node-local contention predictor 32 as shown in FIG. 6, the read/write trigger used to trigger a lookup of the contention predictor 32 may be detection of a read/write coherence transaction received from a given requester 4, 6, 8. The processing behaviour selected based on the predicted level of contention for a given address may be selecting an effective delay in responding to a given request, with the delay being greater in cases of higher contention than in cases of lower contention. The effective delay could be controlled in different ways. For example, to increase the effective delay, the coherence transaction could be processed, but the response sent to the requester in response to the coherence transaction could indicate that the request is rejected and the requester should try again later, to cause a delay in processing the read operation requested using that coherence transaction. Alternatively, the coherence transaction could still be processed without being rejected, but the response to the request could be delayed for a time (e.g. by queuing the request at the home node). Also, as in the processor-local contention predictor example, the processing behaviour selected by the control circuitry 30 within the home node 14 could vary the resulting cache coherency state with which the data is returned to the requester, e.g. changed from Shared to Unique (for reads) or from Unique to Invalid (for writes) in cases of high contention, to try to minimize duration of the critical section and increase the likelihood of successful updates at the requester once the data has been obtained for the read at the start of the critical section.

The contention hints used by the home-node-local contention predictor 32 to train its prediction structure may be different to those hints used by a processor-local contention predictor 32, but similar principles apply to training (increasing confidence in a prediction of high contention in response to an event, metric or signal indicating likely contention, and decreasing confidence in a prediction of high contention otherwise).

For example, one contention hint that could be detected by the home-node-local contention predictor 32 could be instances when one processor 4 requests a cache line indicated by the snoop filter 16 as being held by another processor 4. Another contention hint could be to monitor the state of contended cache lines as they are snooped away from a processor 4. If the line is still clean (or dirty but not updated by this PE), the processor 4 either decided not to write to the line or the line was snooped away too early before the processor 4 got to execute the conditional write. The processor 4 could report the end of critical sections (a successful conditional write) to the home node 14. This would allow the contention predictor 32 in the 14 to understand the length of critical sections and prevent snooping away a line too early.

Another option can be for the contention predictor 32 to detect contention hints based on occupancy of the request queues 50 (e.g. by a metric tracking the fraction of queue slots which relate to requests relating to the same address-if a given address has higher than a threshold fraction of pending requests, it is likely to be more heavily contended).

In the case of a home-node-local contention predictor 32, the prediction data structure 34 used for contention predictor could be combined with the snoop filter 16, so that a combined structure serves as both functions (filtering issuing of snoop requests, and generating contention predictions). This will tend to reduce the lookup overhead compared to looking up two separate structures for snoop filter lookups and contention predictor lookups. For example, when a line is established in the snoop filter, a contention predictor value specified in the same snoop filter entry can be initialized to the No contention state. If a request from one processor 4 hits in a line in the snoop filter that indicates that the corresponding cache line is held by another processor 4, or on snooping a given processor 4 for shared data the line is returned as clean, the contention predictor can be updated to indicate a higher level of contention. Entries will naturally age out when the associated cache line is displaced from the snoop filter. To deal with lines that persist in the snoop filter for a long time without contention, the predictor values can periodically decay (e.g. by decreasing confidence of all prediction values periodically).

Hence, as in the processor-based contention prediction example, the example of FIG. 6 can similarly help improve multi-threaded performance by delaying servicing of read requests from contending threads for a time, to give more time for other threads to complete their critical sections before the read of the contending threads is serviced. This will tend to harm performance of any individual thread, but improve collective update rate across multiple threads in case of high contention levels. When contention is predicted to be lower (there are fewer threads seeking to access the same shared location), an alternative approach with less effective delay introduced in responding to requests is selected, to allow the performance for a single thread to be improved, which for low contention is likely to improve collective performance across a set of threads relatively unlikely to contend for access to the same data with their critical sections.

In examples of FIGS. 4 and 6, the contention predictor is located either at the processor 4 or at the home node 14, not both.

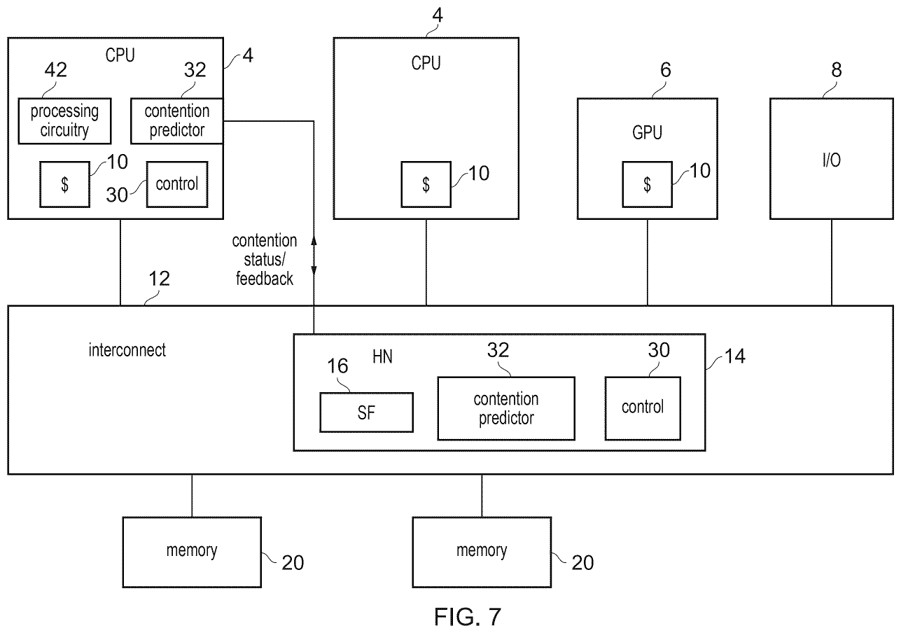

However, as shown in FIG. 7, it is also possible to provide a system 2 which comprises respective contention predictors 32 (and corresponding instances of control circuitry 30) at both a processor 4 and at a home node 14. This combines the embodiments of FIGS. 4 and 6 in one system. While the processor-based contention predictor 32 is shown only for one CPU 4 in the example of FIG. 7, it is possible for more than one CPU 4 in the same system to have a contention predictor 32.

In the case where a processor-local contention predictor is to be used with a home-node local contention predictor, it can be useful for the processor-local and home-node local contention predictors 32 to exchange feedback on predicted levels of contention as shown in FIG. 7. This is because otherwise there could be a scenario where the home node 14 is successfully holding off contention (at a system level), and so the processor-local predictor starts to learn that there is no longer contention and therefore starts generating a greater number of (ultimately useless) speculative transactions which harm performance because they consume slots in home node request queues 50 and may block other more useful requests from being processed. By providing feedback from the home-node-local contention predictor to the processor-local contention predictor, the processor-local contention predictor can prime its prediction structures to indicate a prediction matching the prediction given by the home node 14, so that the control circuitry 30 at the processor 4 can select the second processing behaviour if the home-node-local contention predictor 32 is predicting high contention, even if metrics detected locally to the processor 4 are indicating contention hints indicating lower contention merely due to the fact that the home node 14 is successfully holding off contention to reduce the rate of snoops seen by the processor 4.

The feedback indication provided by the home node's contention predictor to the processor's contention predictor can be implemented in different ways. This feedback could be as simple as the processor 4 being informed that its request was delayed or queued at the home node 14, or could be more complex, e.g. providing additional information such as number of sharers holding the shared data in its private cache 10 and/or the duration of the delay/queue experienced. The feedback could also include the number outstanding requests for the cache line (or other/smaller information to indicate high contention), which the PE local predictor can then use to update the corresponding entry in its contention table 34 to indicate the (high) level of contention.

Additionally, the duration and contention (potentially also confidence and sharers) can be used as feedback to the software developer by exposing the value to performance monitoring hardware. In this use, the processor-local contention predictor would either be programmable in order to hold a specific location (cache line) that the programmer wants to observe the contention/duration of, or would be periodically read by the performance monitoring hardware to find out which locations have been recently contended. This approach is not limited to the example of FIG. 7, but exposing contention predictions to performance monitoring hardware can also be used in the earlier described examples. For example, a statistical profiling unit provided in hardware may be configured to capture a sample record associated with certain sampled instructions executed on a given CPU 4. When a sampled instruction is profiled, the particular information recorded in the sample record may vary depending on configuration information set by the user. One type of information that could be recorded in the sample record (if selected by the user) may, for a load instruction or other instruction capable of causing a read to memory, be the contention prediction provided by the contention predictor 32 for a target address specified by that instruction. The sample record can be stored by the statistical profiling hardware to an identified buffer structure stored in a region of memory, from which the sample records can be read by software or by an external diagnostic apparatus such as a system debugger.

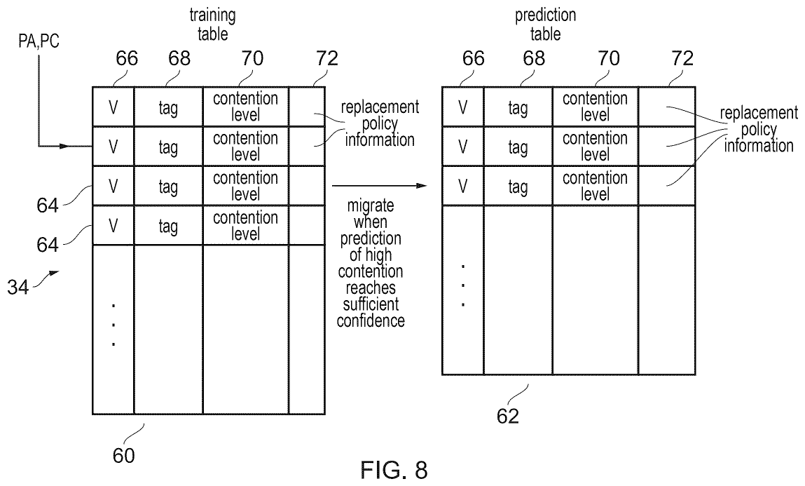

FIG. 8 illustrates an example of a possible implementation of the prediction data structure 34 used in any of the examples of the contention predictor 32 described earlier. It will be appreciated that this is just one possible example, and other implementations may use a different approach.

In this example, the prediction data structure 34 includes a training table 60 used for training before a given threshold level of confidence in high contention prediction is reached, and a prediction table 62 to which entries are migrated once the confidence in high contention prediction has reached the given threshold. Each table 60, 62 comprises a given number of entries 34. The training table 60 could have the same number of entries as the prediction table 62, or a different number of entries. In some examples it may be most efficient for balancing circuit area cost against prediction performance if the training table 60 has a greater number of entries than the prediction table 62, as it is likely in many cases that the number of addresses subject to high contention are small in comparison to the number of addresses having low contention for which training may start but not reach sufficient confidence. Each entry may comprise, for example, a valid indication 66 indicating whether the entry is valid, a tag 68 used to identify whether a given input address corresponds to the entry, a contention level 70 indicating a predicted confidence in the high contention prediction, and replacement policy information 72 (e.g. least recently used values or other replacement policy indications) used to select a victim entry if an entry needs to be replaced to make way for a newer entry. It will be appreciated that other information could also be included.

When evicting a victim entry, it may be preferable to evict unused entries which indicate low contention (or low confidence in high contention), so splitting the table into two structures 60, 62, one table 62 for stable entries (e.g. with known high contention) and a separate table 60 for candidates being trained (new entries with unsure characteristics), can simplify avoiding to evict high contention entries. However, an alternative approach could be to combine structures 60, 62 into one and instead use the contention level field 70 or a replacement policy information field 72 to control replacement selection.

As there are likely many more un-contended than contended locations, this example does not allocate any entries for addresses predicted to have no contention. By only storing entries for addresses which have seen at least one contention hint that is a possible sign of high contention, this can greatly decrease the size of the contention prediction table structures 60, 62. A table miss can therefore correspond to no or low contention.

In this example, the lookup value used to lookup the table is a hash of the physical address (PA) targeted by the read/write trigger with a program counter address (PC) associated with the instruction of the read/write trigger. This approach can work in processor-local contention predictors 32 where the read/write trigger is an instruction. Hashing the PA with the PC for use as an (array) index into the contention table could simplify access and replacements/evictions (reducing the need for set-associative allocation schemes). A tag filter can be used to filter out false positive matching of lookup values corresponding to different PA/PC pairs.

However, in other examples, the PC hashing could be eliminated and the lookup could be based solely on the target address of the read/write trigger. This could be better for examples based on a prefetch read/write trigger or in the home-node-based contention predictor which may not have access to the PC of the instruction that caused a given read transaction to be sent to the home node. In any case, processor-local contention predictors 32 which act on instruction-based read/write triggers could nevertheless ignore the PC and lookup the prediction data structures 34 based solely on the target address of the read/write trigger.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

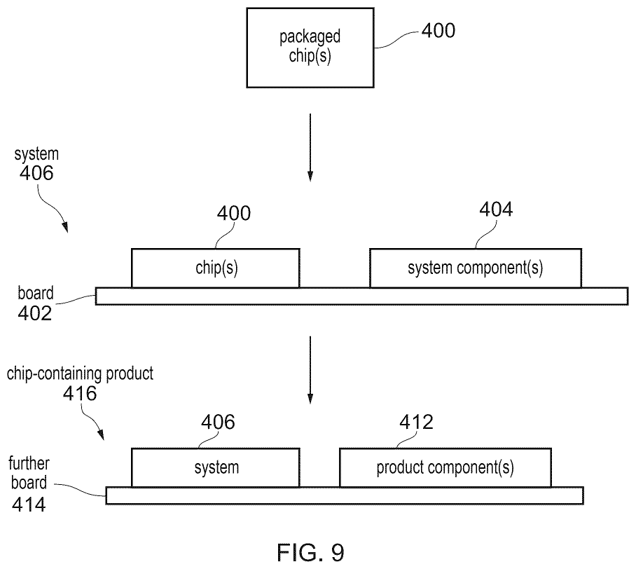

As shown in FIG. 9, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some examples are set out in the following clauses:

1. An apparatus comprising:
a contention predictor configured to predict, in response to a read/write trigger capable of causing a change of coherency state associated with cached data for a target address, a level of contention for access to the data corresponding to the target address; and
control circuitry configured to select, based on the level of contention predicted by the contention predictor, a processing behaviour for processing the read/write trigger.
   2. The apparatus according to clause 1, in which the control circuitry is configured to select, based on the level of contention predicted by the contention predictor, one of:
a first processing behaviour which prioritizes improving single-threaded processing performance over multi-threaded processing performance; and
a second processing behaviour which prioritizes improving multi-threaded processing performance over single-threaded processing performance.
   3. The apparatus according to any preceding clause, in which the control circuitry is configured to select, based on the level of contention predicted by the contention predictor, a timing for issuing or processing a cache coherence transaction associated with the read/write trigger.
   4. The apparatus according to clause 3, in which, the control circuitry is configured to introduce a greater delay in issuing or processing the cache coherency transaction when the contention predictor predicts a higher level of contention than when the contention predictor predicts a lower level of contention.
   5. The apparatus according to any preceding clause, in which the control circuitry is configured to select, based on the level of contention predicted by the contention predictor, a level of speculation aggression associated with speculatively processing the read/write trigger.
   6. The apparatus according to any preceding clause, in which the control circuitry is configured to select, based on the level of contention predicted by the contention predictor, a coherency state in which the data is requested to be cached in a cache in response to the read/write trigger.
   7. The apparatus according to any preceding clause, in which the control circuitry is configured to select, based on the level of contention predicted by the contention predictor, whether to process the read/write trigger using a non-allocating read/write operation which reads/writes data for the target address without allocating the data request into a cache.
   8. The apparatus according to any preceding clause, wherein said change of coherency state comprises a change of coherency state associated with the cached data cached in a cache associated with a given processor;
the apparatus comprises a processor-local contention predictor associated with the given processor; and
the control circuitry is configured to control, based on the level of contention predicted by the processor-local contention predictor, issuing of cache coherence transactions from the given processor to a memory system.
   9. The apparatus according to clause 8, in which the processor-local contention predictor is configured to update the level of contention predicted for a given address based on a conditional write outcome indication indicative of whether a conditional write operation for the given address is successful or failed.
   10. The apparatus according to any of clauses 8 and 9, in which the processor-local contention predictor is configured to update the level of contention predicted for a given address based on a snoop-away period between allocation of data for the given address into the cache and a snoop-triggered change of coherency state for the data for the given address from the cache due to a snoop request received from the memory system.
   11. The apparatus according to any of clauses 8 to 10, in which, in response to a read trigger detected as the read/write trigger, the control circuitry is configured to:
in response to the processor-local contention predictor indicating a lower level of contention, issue, at a first timing prior to commitment of an instruction associated with the read trigger, a request for data corresponding to the target address to be read and allocated into the cache in a shared coherency state; and
in response to the processor-local contention predictor indicating a higher level of contention, issue, at a second timing later than the first timing, a request for data corresponding to the target address to be read and allocated into the cache in an exclusive coherency state.
   12. The apparatus according to any of clauses 8 to 11, in which the given processor is configured to provide, to a home node configured to manage coherency between the cache of the given processor and a cache of at least one other requester, contention status information depending on the level of contention predicted by the processor-local contention predictor.
   13. The apparatus according to any preceding clause, comprising a home-node-local contention predictor associated with a home node configured to manage coherency between a plurality of caches associated with respective requesting nodes; and
the control circuitry is configured to control, based on the level of contention predicted by the home-node-local contention predictor, a processing behaviour for processing a read/write request received from a given requesting node.
   14. The apparatus according to clause 13, in which the home-node-local contention predictor is configured to update the level of contention predicted for a given address based on detection of contention events when one requesting node requests access to a given address for which data is already held in a cache associated with another requesting node.
   15. The apparatus according to any of clauses 13 and 14, in which the home-node-local contention predictor is configured to update the level of contention predicted for a given address based on a previous coherency state associated with data held in a first requesting node's cache for which the previous coherency state is changed to a different coherency state in response to a snoop request triggered by a request from a second requesting node to access the data associated with the given address.
   16. The apparatus according to any of clauses 13 to 15, in which the home-node-local contention predictor is configured to update the level of contention predicted for a given address based on a frequency with which requests targeting the given address are received from the requesting nodes.
   17. The apparatus according to any of clauses 13 to 16, in which the home-node-local contention predictor is configured to provide contention prediction feedback to a processor-local contention predictor associated with a given processor acting as one of the requesting nodes,
the contention prediction feedback being dependent on a prediction of the level of contention by the home-node-local contention predictor for a given target address.
   18. The apparatus according to any preceding clause, in which the contention predictor is configured to predict the level of contention based on looking up a prediction data structure based on at least the target address; and
the contention predictor is configured to update the prediction data structure based on detection of contention hints indicative of an actual level of contention for access to data corresponding to respective addresses.
   19. The apparatus according to clause 18, in which, in response to detecting a miss in a lookup of the prediction data structure based on at least the target address, the contention predictor is configured to predict a lowest level of contention for access to data corresponding to the target address.
   20. The apparatus according to any of clauses 18 and 19, in which the contention predictor is configured to predict the level of contention based on looking up a prediction data structure based a lookup value derived from the target address and a program counter address associated with an instruction corresponding to the read/write trigger.
   21. The apparatus according to any of clauses 18 to 20, in which the prediction data structure comprises a first table structure and a second table structure;
when allocating a new entry in the prediction data structure for a given address for which confidence in prediction of the level of contention has not yet reached a threshold level of confidence, the contention predictor is configured to allocate the new entry in the first table structure; and
in response to a prediction of the level of contention for the given address reaching the threshold level of confidence, the contention predictor is configured to migrate the entry for the given address from the first table structure to the second table structure.
   22. The apparatus according to any of clauses 1 to 21, in which the contention predictor is configured to expose to software an indication of the predicted level of contention for at least one address.
   23. A system comprising:
the apparatus of any preceding clause, implemented in at least one packaged chip;
at least one system component; and
a board,
wherein the at least one packaged chip and the at least one system component are assembled on the board.
   24. A chip-containing product comprising the system of clause 23, wherein the system is assembled on a further board with at least one other product component.
   25. Computer-readable code for fabrication of the apparatus of any of clauses 1 to 22.
   26. A method comprising:
predicting, in response to a read/write trigger capable of causing a change of coherency state associated with cached data for a target address, a level of contention for access to the data corresponding to the target address; and
selecting, based on the level of contention predicted by the contention predictor, a processing behaviour for processing the read/write trigger.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
a contention predictor configured to predict, in response to a read/write trigger capable of causing a change of coherency state associated with cached data for a target address, a level of contention for access to the data corresponding to the target address; and
control circuitry configured to select, based on the level of contention predicted by the contention predictor, a processing behaviour for processing the read/write trigger.

2. The apparatus according to claim 1, in which the control circuitry is configured to select, based on the level of contention predicted by the contention predictor, one of:
a first processing behaviour which prioritizes improving single-threaded processing performance over multi-threaded processing performance; and
a second processing behaviour which prioritizes improving multi-threaded processing performance over single-threaded processing performance.

3. The apparatus according to claim 1, in which the control circuitry is configured to select, based on the level of contention predicted by the contention predictor, a timing for issuing or processing a cache coherence transaction associated with the read/write trigger.

4. The apparatus according to claim 1, in which the control circuitry is configured to select, based on the level of contention predicted by the contention predictor, a level of speculation aggression associated with speculatively processing the read/write trigger.

5. The apparatus according to claim 1, in which the control circuitry is configured to select, based on the level of contention predicted by the contention predictor, a coherency state in which the data is requested to be cached in a cache in response to the read/write trigger.

6. The apparatus according to claim 1, in which the control circuitry is configured to select, based on the level of contention predicted by the contention predictor, whether to process the read/write trigger using a non-allocating read/write operation which reads/writes data for the target address without allocating the data into a cache.

7. The apparatus according to claim 1, wherein said change of coherency state comprises a change of coherency state associated with the cached data cached in a cache associated with a given processor;
the apparatus comprises a processor-local contention predictor associated with the given processor; and
the control circuitry is configured to control, based on the level of contention predicted by the processor-local contention predictor, issuing of cache coherence transactions from the given processor to a memory system.

8. The apparatus according to claim 7, in which the processor-local contention predictor is configured to update the level of contention predicted for a given address based on a conditional write outcome indication indicative of whether a conditional write operation for the given address is successful or failed.

9. The apparatus according to claim 7, in which the processor-local contention predictor is configured to update the level of contention predicted for a given address based on a snoop-away period between allocation of data for the given address into the cache and a snoop-triggered change of coherency state for the data for the given address from the cache due to a snoop request received from the memory system.

10. The apparatus according to claim 7, in which, in response to a read trigger detected as the read/write trigger, the control circuitry is configured to:
in response to the processor-local contention predictor indicating a lower level of contention, issue, at a first timing prior to commitment of an instruction associated with the read trigger, a request for data corresponding to the target address to be read and allocated into the cache in a shared coherency state; and
in response to the processor-local contention predictor indicating a higher level of contention, issue, at a second timing later than the first timing, a request for data corresponding to the target address to be read and allocated into the cache in an exclusive coherency state.

11. The apparatus according to claim 1, comprising a home-node-local contention predictor associated with a home node configured to manage coherency between a plurality of caches associated with respective requesting nodes; and
the control circuitry is configured to control, based on the level of contention predicted by the home-node-local contention predictor, a processing behaviour for processing a read/write request received from a given requesting node.

12. The apparatus according to claim 11, in which the home-node-local contention predictor is configured to update the level of contention predicted for a given address based on detection of contention events when one requesting node requests access to a given address for which data is already held in a cache associated with another requesting node.

13. The apparatus according to claim 11, in which the home-node-local contention predictor is configured to update the level of contention predicted for a given address based on a frequency with which requests targeting the given address are received from the requesting nodes.

14. The apparatus according to claim 11, in which the home-node-local contention predictor is configured to provide contention prediction feedback to a processor-local contention predictor associated with a given processor acting as one of the requesting nodes,
the contention prediction feedback being dependent on a prediction of the level of contention by the home-node-local contention predictor for a given target address.

15. The apparatus according to claim 1, in which the contention predictor is configured to predict the level of contention based on looking up a prediction data structure based on at least the target address; and
the contention predictor is configured to update the prediction data structure based on detection of contention hints indicative of an actual level of contention for access to data corresponding to respective addresses.

16. The apparatus according to claim 15, in which, in response to detecting a miss in a lookup of the prediction data structure based on at least the target address, the contention predictor is configured to predict a lowest level of contention for access to data corresponding to the target address.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A non-transitory storage medium storing computer-readable code for fabrication of the apparatus of claim 1.

20. A method comprising:
predicting, in response to a read/write trigger capable of causing a change of coherency state associated with cached data for a target address, a level of contention for access to the data corresponding to the target address; and
selecting, based on the level of contention predicted by the contention predictor, a processing behaviour for processing the read/write trigger.
